(19) United States
(12) Patent Application Publication
(10) Pub. No.: US 2026/0087164 A1
(43) Pub. Date: Mar. 26, 2026

(54) SYSTEM AND METHOD FOR VECTOR-BASED VERIFICATION OF GENERATIVE AI OUTPUTS

(71) Applicant: Wells Fargo Bank, N.A., San Francisco, CA (US)

(72) Inventors: Rameshchandra Bhaskar Ketharaju, Hyderabad (IN); Anjeet Kumar, Bangalore (IN); Naveen Rathani, Bengaluru (IN); Shuvam Sengupta, Kolkata (IN); Tapan Totla, Bangalore (IN)

(21) Appl. No.: 18/897,516

(22) Filed: Sep. 26, 2024

(51) Int. Cl. G06F 21/62; G06F 21/84

(52) U.S. Cl. CPC G06F 21/6227; G06F 21/84

(57) ABSTRACT

A method may include receiving, using a processing unit, a prompt for a generative artificial intelligence model from a computing device; identifying, using the processing unit, an entity in the prompt; querying a knowledge graph for verified information associated with the entity; inputting, using the processing unit, the prompt into the generative artificial intelligence model; in response to the inputting, receiving a generated response from the generative artificial intelligence model; generating a similarity value between the generated response and the verified information; determining that the similarity value is below a threshold similarity; and based on the determining, preventing a display of the generated response.

### BACKGROUND

Virtual assistants may be implemented in several manners. For example, a virtual assistant may use a rigid rule-based structure in which a user selects options from a determined list. Another virtual assistant may use natural language processing to try and understand the intent of a user's prompt to guide them to an answer. Generative artificial intelligence uses a transformer-based machine learning model to formulate responses.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Like numerals having different letter suffixes may represent different instances of similar components. Some embodiments are illustrated by way of example, and not limitation, in the figures of the accompanying drawing.

FIG. 1 is a block diagram of elements of a client device and an application server, according to various examples.

FIG. 2 is a block diagram illustrating a method of modifying a prompt, according to various examples.

FIG. 3 is a block diagram illustrating a method of generating similarity values between a knowledge graph and a generated response of a generative artificial intelligence model, according to various examples.

FIG. 4 is a block diagram illustrating a machine in the example form of a computer system, within which a set or sequence of instructions may be executed to cause the machine to perform any one of the methodologies discussed herein, according to various examples.

### DETAILED DESCRIPTION

The following description outlines examples to provide a thorough understanding of various inventive aspects. It will be evident, however, to one skilled in the art that the present invention may be practiced without these specific details. References in the specification to “one example,” “an example,” “an illustrative example,” etc., indicate that the example described may include a particular feature, structure, etc. Still, every example may not necessarily include that particular feature. Additionally, such phrases do not imply a single example, and the features may be incorporated into other examples described. It may be appreciated that lists in the form of “at least one A, B, and C” may mean (A); (B); (C): (A and B); (B and C); or (A, B, and C). Similarly, items listed in the form of “at least one of A, B, or C” can mean (A); (B); (C): (A and B); (B and C); or (A, B, and C). Furthermore, using such phrases does not negate the possibility of other options (e.g., (D)).

Throughout this disclosure, components may perform electronic actions responding to different variable values (e.g., thresholds, user preferences, etc.). As a matter of convenience, this disclosure does not always detail where the variables are stored or how they are retrieved. In such instances, it may be assumed that the variables are stored on a storage device (e.g., Random Access Memory (RAM), cache, hard drive) accessible by the component via an Application Programming Interface (API) or other program communication method. Similarly, the variables may be assumed to have default values should a specific value not be described. End-users or administrators may use user interfaces to edit the variable values.

In various examples described herein, user interfaces are described as being presented to a computing device. The presentation may include data transmitted (e.g., a hypertext markup language file) from a first device (such as a web server) to the computing device for rendering on a display device of the computing device via a web browser. Presenting may separately (or in addition to the previous data transmission) include an application (e.g., a stand-alone application) on the computing device generating and rendering the user interface on a display device of the computing device without receiving data from a server.

Furthermore, the user interfaces are often described as having different portions or elements. Although in some examples, these portions may be displayed on a screen simultaneously, in others, the portions/elements may be displayed on separate screens such that not all portions/elements are displayed simultaneously. Unless explicitly indicated as such, the use of “presenting a user interface”does not infer either one of these options.

Additionally, the elements and portions are sometimes described as being configured for a particular purpose. For example, an input element may be configured to receive an input string, a selection from a menu, a checkbox, etc. In this context, “configured to” may mean presenting a user interface element capable of receiving user input. “Configured to” may additionally mean computer executable code processes interactions with the element/portion based on an event handler. Thus, a “search” button element may be configured to pass text received in the input element to a search routine that formats and executes a structured query language (SQL) query to a database.

Artificial intelligence (AI), machine learning (ML) algorithms, and neural networks are often used interchangeably, but they are, in fact, a set of nested concepts. AI is the broadest term, encompassing any technique that enables computers to mimic human intelligence. This includes anything from rule-based systems to advanced learning algorithms. Examples of AI applications include expert systems for medical diagnosis, game-playing AI like chess computers, smart home systems, and autonomous vehicles.

ML is a subset of AI that focuses on algorithms that can learn from and make predictions or decisions based on data. Instead of being explicitly programmed, these systems improve their performance as they are exposed to more data over time. ML may be used in applications such as spam email detection, recommendation systems for streaming services and e-commerce, credit scoring in financial services, and predictive maintenance in manufacturing.

Neural networks (also referred to as artificial neural networks(ANN)) are a specific type of machine learning algorithm loosely based on the structure and function of the human brain. A neural network includes interconnected nodes (neurons) organized in layers, capable of learning complex patterns in data. Neural networks are often applied in image classification, speech recognition, time series forecasting for stock prices, and anomaly detection in cybersecurity.

Deep Learning is a subset of neural networks using multiple layers to extract higher-level features from raw input. This allows for more sophisticated learning and representation of complex patterns. Deep learning may be used in facial recognition systems, advanced natural language processing, self-driving car perception systems, and medical image analysis for disease detection. Large Language Models (LLMs), also referred to as generative AI (GenAI), are a type of deep learning model specifically designed for processing and generating human-like text. LLMs are used in conversational AI, automated content generation, advanced language translation, and code generation tools.

One problem with GenAI is their tendency to “hallucinate” in their responses. Hallucinations occur when LLMs generate plausible-sounding but incorrect or nonsensical information. The problem generally stems from how an LLM generates a response. At a high level, an LLM uses a transformer model that uses “attention” to determine the most likely word given the prior word, the prompt, and the training data. In this manner, an LLM may be considered a much more sophisticated auto-complete. However, like auto-complete, an LLM does not comprehend or use logic in the traditional sense of those words. Accordingly, outputs from an LLM are compelling because they confidently respond to a request. For example, if a user asks an LLM to analyze a document and provide a summary, the output may authoritatively include quotes that do not exist in the document.

If a user interacts with an LLM for creative purposes, hallucinating may be beneficial. However, hallucinations present significant challenges if an LLM is being used as part of a chatbot for customer service or internally to analyze company documents. For example, if an LLM summarizes a user's financial history, the response should be grounded in truth.

Various techniques have been tried to increase the accuracy of ML models (not just LLMs). The techniques may be categorized as either architecture techniques or training data techniques. Hyperparameters are settings that govern the training process and the structure of the model, rather than the internal parameters (e.g., weights) learned from the data. Examples include learning rate, batch size, number of layers, and number of neurons in a neural network. Unlike model parameters, hyperparameters are set before training and influence how the model learns. Adjusting hyperparameters may impact the performance and accuracy of a model. Independent of hyperparameters, training data compilation has a large impact on the accuracy of a model. High-quality data with accurate labeling reduces noise and errors, allowing the model to learn true patterns. Furthermore, balanced datasets prevent bias toward frequent classes (e.g., overfitting).

However, these improvements do not fully address the hallucination problem in LLMs. This issue stems from the inherent probabilistic nature of generating responses. While better training data and hyperparameter tuning can reduce the frequency of hallucinations by refining the model's learning process, they cannot eliminate them entirely.

This disclosure provides one or more solutions to address the problems above, which in at least one example includes a two-pronged solution. The first prong focuses on before a user prompt is submitted to a GenAI model, and the second prong focuses on identifying potential problems in the generated response. For example, not all hallucinations are bad depending on the context of the prompt itself. However, a user may not realize that their prompt is being interpreted (by the GenAI model) as asking for some degree of creativity in the response. It is appreciated, that in certain situations asking for creativity may result in undesirable hallucinations in the response. Accordingly, a method is described to classify the prompt, and if the prompt is classified as “creative” (or “too creative”), a message may be presented asking the user to rewrite their prompt. Alternatively, or additionally, the prompt may be automatically rewritten to remove terminology that may be interpreted as giving creative license to the GenAI model (e.g., explicitly or implicitly requesting creativity in the response from the GenAI model).

Another aspect may be to use natural language processing (NLP), such as named entity recognition (NER), to identify potentially ambiguous entities. For example, the same term may be referring to a person in some instances, a business, a band in others, or a street name. If a system cannot readily determine which of the possible entities the term refers to, a request for more information may be presented to the user.

The generated response from the GenAI model may be analyzed for hallucinations prior to being presented to a user. For example, a similarity value may be generated between verified information about entities in the prompt compared to generated information in the response. The similarity value may be a calculated cosine similarity value between the verified information and generated information. The similarity value may be calculated across multiple categorical dimensions and for multiple entities in the prompt/response. The similarity value acts as a proxy for hallucinations. For example, if the generated geographic information for an entity differs from the verified geographic information for the entity, the GenAI model has likely hallucinated. If the similarity value is not above a certain threshold indicative of a low risk of hallucinations, the response may be withheld from presentation to the requesting user rather than presenting a potentially inaccurate response.

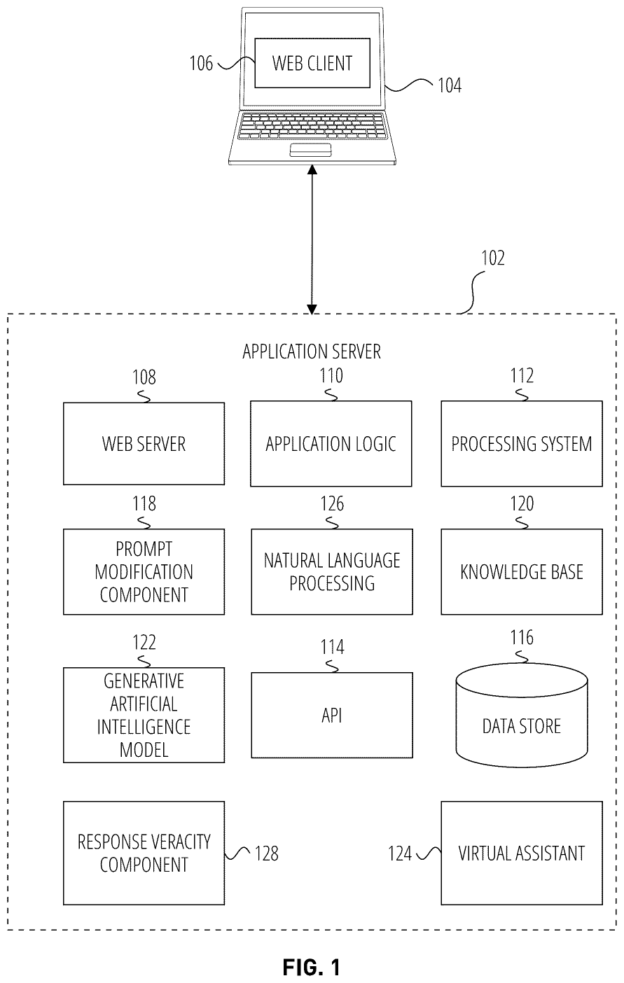

FIG. 1 illustrates the components of a client device and an appication server according to various examples. FIG. 1 includes an application server 102, a client device 104, a web client 106, a web server 108, an application logic 110, a processing system 112, an API 114, a data store 116, a prompt modification component 118, a knowledge base 120, a GenAI model 122, a virtual assistant 124, NLP component 126, and response veracity component 128.

In the environment illustrated by FIG. 1, different types of users may interact with the system in various ways, enhancing the flexibility and utility of the application. For instance, an end-user, such as a customer, might use the client device 104 to engage with the virtual assistant 124. This virtual assistant may use the GenAI model 122 to generate responses that are tailored to the user's inquiries or needs. Another use case may be a customer service agent accessing and analyzing customer data using the virtual assistant 124.

Application server 102 is illustrated as a set of separate elements (components, logic, servers, etc.). However, the functionality of multiple individual elements may be performed by a single element. An element may represent computer program code executable by processing system 112. The program code may be stored on a storage device (e.g., data store 116) and loaded into the memory of the processing system 112 for execution. Portions of the program code may be executed in parallel across multiple processing units. A processing unit may be a grouping of one or more cores of a general-purpose computer processor, a graphical processing unit, an application-specific integrated circuit, or a tensor processing core. Furthermore, the grouping may operate on a single device or multiple devices (either collocated or geographically dispersed). Accordingly, code execution using a processing unit may be performed on a single device or distributed across multiple devices. In some examples, using shared computing infrastructure, the program code may be executed on a cloud platform (e.g., MICROSOFT AZURE® and AMAZON EC2®).

Client device 104 may be a computing device which may be but is not limited to, a smartphone, tablet, laptop, multi-processor system, microprocessor-based or programmable consumer electronics, game console, set-top box, or other device that a user utilizes to communicate over a network. In various examples, a computing device includes a display module (not shown) to display information (e.g., specially configured user interfaces). In some embodiments, computing devices may comprise one or more of a touch screen, camera, keyboard, microphone, or Global Positioning System (GPS) device.

Client device 104 and application server 102 may communicate via a network (not shown). The network may include local-area networks (LAN), wide-area networks (WAN), wireless networks (e.g., 802.11 or cellular network), Public Switched Telephone Network (PSTN), ad hoc networks, cellular, personal area networks or peer-to-peer (e.g., Bluetooth®, Wi-Fi Direct), or other combinations or permutations of network protocols and network types. The network may include a single Local Area Network (LAN), Wide-Area Network (WAN), or combinations of LANs or WANs, such as the Internet.

In some examples, the communication may occur using an application programming interface (API) such as API 114. An API provides a method for computing processes to exchange data. A web-based API (e.g., API 114) may permit communications between two or more computing devices, such as a client and a server. The API may define a set of HTTP calls according to Representational State Transfer (RESTful) practices. For example, A RESTful API may define various GET, PUT, POST, and DELETE methods to create, replace, update, and delete data stored in a database(e.g., data store 116).

Additionally, API 114 serves as an interface within the application server 102 facilitating data exchange and functions across various components. For example, the virtual assistant 124 may utilize API 114 to interact with the GenAI model 122. The virtual assistant 124 may submit user queries to the GenAI model 122 and receive the generated responses for presentation to the user. Similarly, the virtual assistant 124 may pass the generated responses via API 114 to the response veracity component 128 prior to the presentation. Additionally, API 114 may enable the NLP component 126 to access data from the knowledge base 120.

Application server 102 may include web server 108 to enable data exchanges with client device 104 via web client 106. Although generally discussed in the context of delivering webpages via the Hypertext Transfer Protocol (HTTP), other network protocols may be utilized by web server 108 (e.g., File Transfer Protocol, Telnet, Secure Shell, etc.). A user may enter a uniform resource identifier (URI) into web client 106 (e.g., the INTERNET EXPLORER® web browser by Microsoft Corporation or SAFARI® web browser by Apple Inc.) that corresponds to the logical location (e.g., an Internet Protocol address) of web server 108. In response, web server 108 may transmit a web page rendered on a client device's display device (e.g., a mobile phone, desktop computer, etc.).

Additionally, the web server 108 may enable users to interact with one or more web-based applications. A web application may provide user interface (UI) components rendered on a display device of the client device 104. The user may interact (e.g., select, move, enter text into) with the UI components, and, based on the interaction, the web application may update one or more portions of the web page. A web application may be executed in whole or in part locally on client device 104. The web application may populate the UI components with data from external or internal sources (e.g., data store 116) in various examples. For example, a web application may include an interface for a user to interact with the virtual assistant 124.

The web application may be executed according to application logic 110. Application logic 110 may use the various elements of application server 102 to implement the web application. For example, application logic 110 may issue API calls to retrieve or store data from data store 116 and transmit it for display on client device 104. Similarly, data entered by a user into a UI component may be transmitted using API 114 back to the web server. Application logic 110 may use other elements (e.g., prompt modification component 118, knowledge base 120, GenAI model 122, virtual assistant 124, NLP component 126, and response veracity component 128) of application server 102 to perform functionality associated with the web application as described further herein.

Data store 116 may store data that is used by application server 102. Data store 116 is depicted as a singular element but may be multiple data stores. In various examples, the knowledge base 120 may be part of the data store 116. The data store 116 may include several databases of varying model architectures such as, but not limited to, a relational database (e.g., SQL), a non-relational database (NoSQL), a flat-file database, an object model, a document details model, graph database, shared ledger (e.g., blockchain), or a file system hierarchy. Data store 116 may store data on one or more storage devices (e.g., a hard disk, random access memory (RAM), etc.). The storage devices may be in standalone arrays, part of one or more servers, and located in one or more geographic areas. Data structures may be implemented in several ways depending on the programming language of an application or the database management system used by an application. For example, if C++ is used, the data structure may implemented as a struct or class. In the context of a relational database, a data structure may be defined in a schema.

Data store 116 may store data (e.g., a user profile) on users of application server 102. A user profile may include credential information such as a username and hash of a password. A user may enter their username and plaintext password on a login page of application server 102 to view their user profile information or interfaces presented by application server 102 in various examples. There may be different roles for a user account. For example, there may be a customer service representative user account and an end-user user account.

The knowledge base 120 may store verified information about entities (e.g., people, places, user accounts) in a standardized format. The knowledge base 120 may be structured as a knowledge graph using subject, predicate, object (SOP) tuple notation. A query language, such as SPARQL Protocol and Resource Description Framework (RDF) Query Language (SPARQL), is utilized to retrieve information from the knowledge base 120. The entities that have verified information in knowledge base 120 may correspond to entities identifiable using entity recognition (NER) NPL techniques.

The knowledge base 120 may store verified information across multiple domains, such as geographic and temporal domains. For example, there may be information that identifies a person by name, the past locations they have lived, and a time period when they were alive. As discussed in more detail below, this information may be used when response veracity component 128 calculates a similarity value.

Data in the knowledge base 120 may originate from several sources. For example, business-specific data may include proprietary company information, operational metrics, and industry-specific benchmarks for business analytics and decision-making processes. This data may be collected internally. Customer-specific data may include transaction histories, user behavior analytics, preferences, account information, etc. The knowledge base 120 may also include general knowledge such as widely accepted facts, historical data, geographical information, and common knowledge across various domains. This general knowledge may be obtained from third-party data services and stored locally or accessed in real time over an API.

NLP component 126 may be used to parse prompts received from a user and responses generated by GenAI model 122. NLP involves various techniques to help computers understand, interpret, and respond to language-based inputs. One of these techniques is Named Entity Recognition (NER), which identifies and classifies entities in a text into predefined categories such as names of persons, organizations, locations, dates, etc. Parsing text using NLP may involve text preprocessing. The processing may include tokenization (e.g., splitting the prompt into words or phrases, normalization (e.g., converting to a uniform format, such as lowercasing and removing punctuation), and removal of common words (e.g., to, is, and the). The remaining elements in the prompt may then be categorized according to predefined types such as Person, Organization, Location, Date, etc.

NLP component 126 may also be used to determine the intent of a prompt. For example, one intent technique is to use pattern-matching NER classification types. A pattern such as “Find transaction from [Location] on [Date]” may be matched to a transaction lookup intent. Semantic intent techniques go beyond just recognizing keywords and instead analyze the relationships and meanings of words. For instance, one method uses word embeddings, which map words to vectors in a way that captures their meanings and relationships.

Another aspect of intent processing may be to classify a prompt on a creative intent scale. For example, different patterns may be classified as “creative” or “factual.” The transaction lookup intent may be classified as factual. A pattern such as “Please write a story about [Person] in [Place]” may be classified as creative. In various examples, a prompt may be assigned a creative intent value. The creative intent value may be a scale from 0-1 (although other scales may be used), with a ‘1’ representing a creative intent and a ‘0’ representing a non-creative intent. Different machine learning models may be used to generate the creative intent value. For example, a neural network may be trained using a labeled data set. The dataset may include a prompt and a classification of the prompt as either having a creative intent or non-creative intent.

Conversational agents, also referred to as chatbots or virtual assistants (such as virtual assistant 124), are software applications designed to simulate human-like conversations with users through text or voice interactions. These intelligent systems leverage a combination of pre-programmed rules and various forms of artificial intelligence (AI), including natural language processing (NLP) and machine learning (ML), to understand and respond to user queries naturally and intuitively. The underlying technology enables chatbots to process and interpret human language, recognize user intent, and generate relevant responses, facilitating interaction between the machine and human users. Conversational agents may be distinguished from pure Interactive Voice Response (IVR) systems in which a hierarchical menu is navigated using user selections (e.g., via a number pad on their phone) with no ML or AI.

Virtual assistant 124 may capture user input, which may be in the form of text or voice (via web client 106). Regarding text input, virtual assistant 124 may directly process the input. Speech recognition technology may be used to convert spoken language into text format for voice inputs. However, unlike a regular assistant, which is tied to an embedded model (e.g., GenAI model 122), virtual assistant 124, virtual assistant 124 may perform processing on the prompt prior to submission to a GenAI model 122.

For example, imagine a customer service representative interacting with virtual assistant 124 to find information about a customer named George Washington. The representative types in the prompt: “Please give me details on George Washington.” However, GenAI model 122 might interpret “George Washington” as referring to the US president. Thus, the response to the prompt may be details about the historical figure, such as his role in the American Revolution, his presidency, etc.

The customer service representative, however, needs information about a customer, such as their account details, purchase history, or recent interactions. Accordingly, NLP component 126 may flag the ambiguity and request clarification from the representative. Alternatively, the prompt modification component 118 may be configured to default to entities that match entities in knowledge base 120 (e.g., a customer's name) and rewrite the prompt automatically.

A further difference from traditional virtual assistants is that a response from GenAI model 122 (one that is passed to virtual assistant 124) may first be checked by response veracity component 128 before presentation to the requesting user. A more detailed example of how response veracity component 128 may be used is discussed in the following figures.

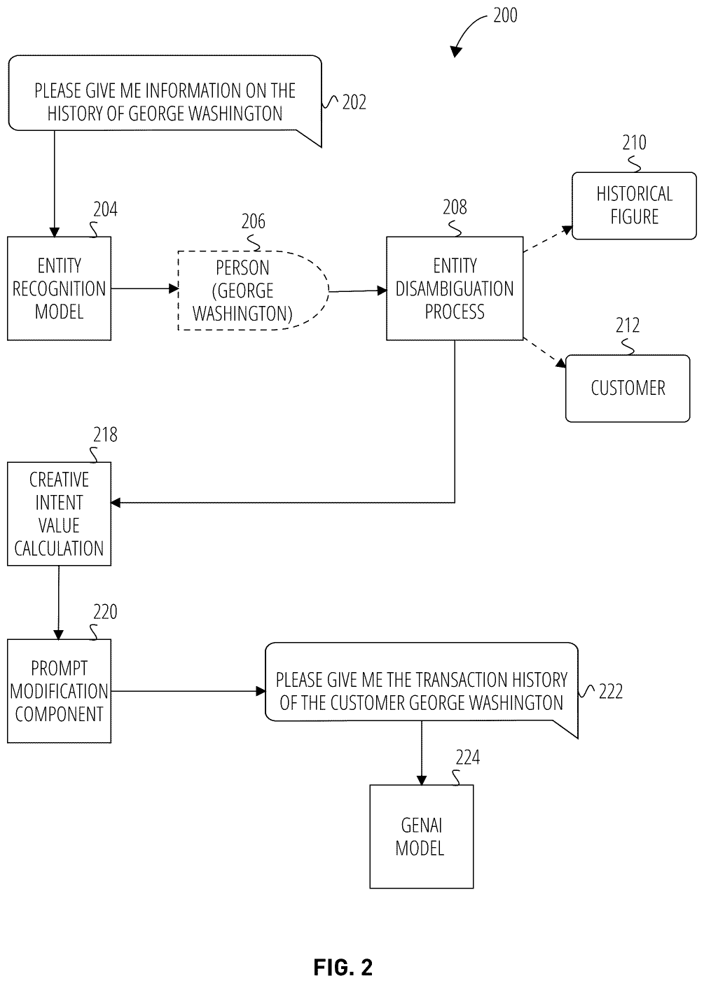

FIG. 2 is a block diagram 200 illustrating a method of modifying a prompt, according to various examples. As indicated previously, one of the reasons GenAI models produce hallucinations or non-relevant results is the lack of clarity in the prompt itself. Accordingly, FIG. 2 illustrates an example technique to modify the prompt to reduce the likelihood of an inaccurate or non-relevant answer. The method may be implemented in an environment such as in FIG. 1. For example, the original prompt 202 may be entered by a client device (e.g., client device 104) via a virtual assistant (e.g., virtual assistant 124). Furthermore, the actions described in FIG. 2 may be an example implementation of prompt modification component 118, according to various examples. Accordingly, FIG. 2 may refer back to components of FIG. 1. However, FIG. 2 may also operate in other technical environments.

The method may begin with receiving, using a processing unit (e.g., part of processing system 112), a prompt for a generative artificial intelligence model from a computing device. The prompt may have been entered by a customer service representative who wishes to obtain information on a customer before a meeting or phone call with the customer. In the example of FIG. 2, the prompt is “Please give me information on the history of George Washington.”

The original prompt 202 may be inputted into an entity recognition model (e.g., entity recognition model 204) to identify entities in the prompt. The entity recognition model 204 may be part of a natural language processing component (e.g., NLP component 126). The method may then, in response to the inputting, receive an output from the entity recognition model 204. The output may identify a set of entities in the prompt and a weight for each entity in the set of entities. The weight may represent the importance of the entity relative to other entities in the set of entities in the prompt.

For example, in original prompt 202, person entity 206 may be identified using the NER techniques described for NLP component 126 in FIG. 1. One method for determining the weight of an entity relative to others is to use frequency of occurrence. Thus, an entity that appears twice is twice as “important” relative to entities that appear once. Weights may also be assigned based on the type of entity. For example, a data table may identify that a “Person” entity type is 50% more important than a “Place” entity type. Another method for determining weights may be to use a transformer machine learning model. A transformer model processes text and outputs attention values for tokens (one or more parts of a word) in the text. A higher attention value may correlate with a higher relevance (e.g., weight) for that token with respect to the other tokens in the text.

To avoid asking endless questions about possible ambiguous entities, the method may select entities for further processing based on the determined weights. For example, the entity recognition model 204 may identify ten different entities, but only the top three may have the entity disambiguation process 208 performed. In the example of FIG. 2, consider that person entity 206 has been selected for possible disambiguation.

The entity disambiguation process 208 may calculate an entity ambiguity score for any selected entities. The entity disambiguation process 208 may be implemented in different ways. For example, using person entity 206, one method may be to query a knowledge graph (e.g., stored as part of knowledge base 120) to determine how many Person entities have the name “George Washington.” If there is more than one, a request may be transmitted back to the requesting user for a more precise description of which George Washington the user intends.

Another method may be to use clustering algorithms (e.g., k-mean clustering) that group entities based on the similarity of their attributes and relationships. By clustering the contexts in which “George Washington” appears in the knowledge graph, distinct clusters representing different individuals may be uncovered. For instance, one cluster might contain attributes related to the 18th-century president (e.g., person type 210), while another cluster might include attributes related to a customer (e.g., person type 212). Multiple clusters for “George Washington” may indicate potential ambiguity.

Another method may be calculating cosine similarity, which measures the cosine of the angle between two vectors in a multi-dimensional space and represents how similar two entities are based on their attributes. In the case of “George Washington,” vectors representing the contextual attributes (such as historical events, dates, and associated people) of different “George Washington” nodes can be compared. A high cosine similarity score would indicate that the entities are likely the same, while a low score suggests ambiguity and the presence of distinct entities.

Accordingly, in various examples, after the entity disambiguation process 208, it may be determined that an entity ambiguity score exceeds threshold. The entity ambiguity score may differ depending on the method used to calculate the score. For example, if a simple count of entities is used, the threshold may be set to one. Accordingly, if there is more than one entity with the same identifier (e.g., name), a prompt requesting additional information about the entity for clarification may be transmitted. If cosine similarity is used, the threshold may be based on the cosine similarity values between nodes having the same identifier. For example, if there are not two nodes that have a cosine similarity value above 0.7, it may be determined clarification should be requested.

The request for additional information may include details from the knowledge graph to help the user. For example, in the case of person entity 206, the request for additional information may include a list of the nodes in the knowledge graph that have George Washington as a name and demographic information (e.g., age, location) about the various matching nodes. A user may select a node (e.g., using an input device or entering a numeral listed by the node) to indicate which George Washington was intended. The user may also transmit additional information (e.g., further identifying details) about the entity if the presented list is incorrect or incomplete.

In addition to an entity ambiguity score, block diagram 200 includes a creative intent value calculation 218. Calculating the creative intent value of the prompt may be implemented using an NLP such as NLP component 126. A higher creative intent value may correspond to a higher likelihood of a hallucinatory response. Thus, based on determining the creative intent value exceeds a threshold, a response may be transmitted to the computing device that sent original prompt 202 requesting an update to the original prompt 202. The request may include information that informs the user that their prompt may be too open-ended to obtain a completely factual response. In response, the user may transmit an update to the original prompt 202.

In various examples, automatic modifications may be made to the original prompt 202 using prompt modification component 220. The modifications may be based on user responses transmitted after the entity disambiguation process 208 and creative intent value calculation 218. For example, if the user identifies the customer “George Washington,” the prompt may be rewritten as identified in modified prompt 222. The automatic modifications may include adding details about an entity to the prompt derived from the knowledge graph. A knowledge graph triple may be “George Washington is a customer.” Thus, the prompt may be modified to indicate George Washington is a customer and not the past president.

In various examples, prompt modification component 220 (which may be implemented as prompt modification component 118 from FIG. 1) may use a GenAI model to rewrite the prompt based on the user's responses. For example, creative intent value calculation 218 may indicate that “information” is too creative, and the user may respond with “I am looking for transaction history information.” A request may be transmitted (e.g., from prompt modification component 220) to rewrite the prompt using the additional information to a GenAI model. The GenAI model may be the same as the eventual model that receives modified prompt 222 or a separate model that has been trained to produce direct questions (as opposed to open-ended questions). After the prompt has been updated (either by a user or automatically), it may be inputted into GenAI Model 224.

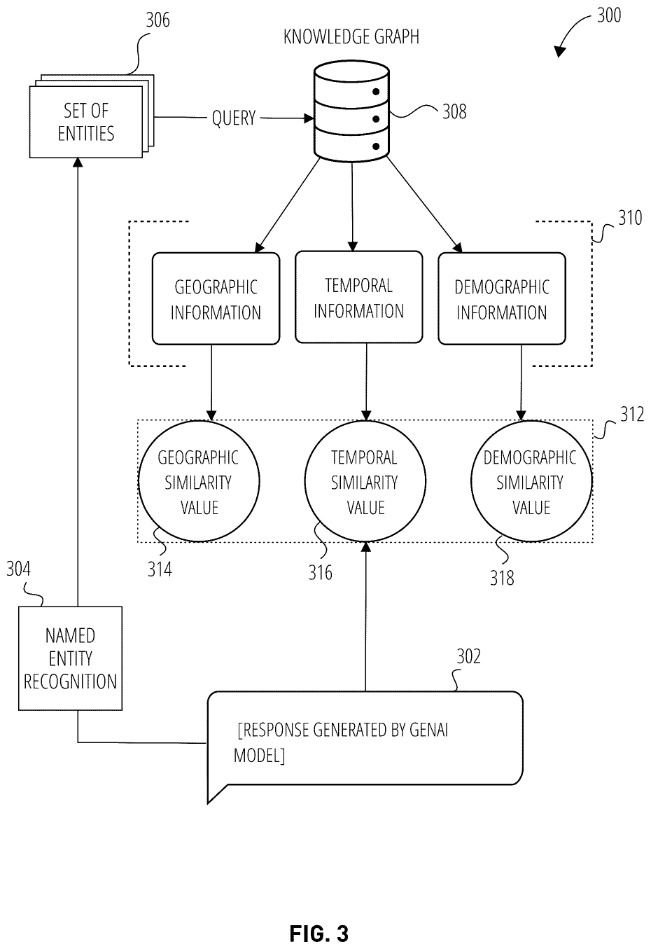

FIG. 3 is a block diagram 300 illustrating a method of generating similarity values between a knowledge graph and a generated response of a generative artificial intelligence model, according to various examples. In various examples, prior to a generated response (e.g., generated response 302) being presented to a user, a similarity value calculation may be performed as a proxy for whether or not the response includes non-factual information.

The functionality described in FIG. 3 may be part of the operating environment discussed in FIG. 1 but may also operate in other technical environments. For example, a user may have input a prompt via virtual assistant 124 to GenAI model 122. In response to the input, GenAI model 122 may have output generated response 302. The generated response 302 may be processed by named entity recognition 304 to generate the set of entities 306. The set of entities 306 may be limited to certain types of entities, such as Person, Time, and Geographic types.

Knowledge graph 308 may be configured to store verified information about entities across multiple categorical dimensions. The knowledge graph 308 may be stored in a graph database format, which includes nodes (also known as vertices), edges (also known as links or relationships), and properties (also known as attributes). A semantic ontology using subject-predicate-object notation may be used to store verified information about entities across multiple categorical dimensions. For example, a geographic dimension may store information about where a person lived, a temporal dimension about when a person lived/is living, and a demographic dimension may be information such as job, age, etc.

The knowledge graph 308 may be queried for verified information associated with the entity(s) in the set of entities 306 across multiple categorical dimensions. For example, if a person is identified, a query may be made to obtain values for an age property and a job property. The information may be collected and encoded in verified information vector 310 as text embeddings.

To convert a paragraph of text into a text embedding, the information resulting from the queries may be broken down into individual words or tokens. Each token may represent a word, in various examples. Following tokenization, the information may be preprocessed to remove stopwords (e.g., “the,” “is,” and “in”), eliminate punctuation, and perform normalization tasks such as stemming (e.g., swimming to swim).

Once the information has been processed, the embedding generation may be performed. This may include converting each token into a numerical vector using a pre-trained model such as Word2Vec, GloVe, or BERT. These models map words to high-dimensional space, capturing semantic meanings and relationships between words. Each word is represented by a dense vector, where similar words have vectors that are close together in this space. After obtaining the vectors for individual tokens, the vectors are aggregated to form a single vector representing the entire set of information received from the queries. An aggregation method may include averaging or summing the vectors so the resulting embedding is a fixed-size vector that encapsulates the semantic content of the text.

Verified information vector 310 may include three different embedding categories: a geographic information embedding, a temporal information embedding, and a demographic information embedding that represent the results of three separate queries. In other examples, a single embedding may be used that aggregates and averages all the embeddings across multiple categorical dimensions.

After the verified information vector 310 has been created, a similarity value between the generated response and the verified information may be calculated. The similarity value may be a single similarity value or a set of similarity values (e.g., similarity values 312), one for each of the multiple categorical dimensions. For example, a geographic similarity value 314 may be a cosine similarity value based on the verified information of the entity for the geographic dimension and the generated response, a temporal similarity value 316 may be a cosine similarity value based on the verified information of the entity for the temporal dimension and the generated response, and a demographic similarity value 318 may be a cosine similarity value based on verified information of the entity for the demographic dimension and the generated response.

A cosine similarity value is a metric that quantifies the cosine of the angle between two vectors and provides a measure of their directional similarity. The value ranges from −1 to 1, where 1 indicates that the vectors are identical, 0 means they are orthogonal, and −1 signifies that they are diametrically opposed. When used with text embeddings, this similarity measure indicates the semantic relevance of two embeddings with higher values indicating more semantically alike.

To calculate the cosine similarity values, a text embedding may be generated from the generated response 302 in the same manner as discussed for the information in verified information vector 310. Accordingly, the resulting embedding of the generated response 302 may have the same fixed-vector size as the embeddings in the verified information vector 310. In various examples, multiple embeddings may be generated from generated response 302 in accordance with the multiple categorical dimensions. For example, NLP component 126 may retrieve the geographic information from the generated response 302 (e.g., using named entity recognition 304) and use that information as the basis for geographic similarity value 314 comparison. Consequently, if the cosine similarity value between the embedding of the generated response 302 and the geographic similarity value 314 is below a threshold similarity (e.g., below 0.5), it may indicate that the generated response 302 is potentially hallucinating along the geographic dimension. Different threshold similarity values may be used for different dimensions (e.g., a demographic dimension may use 0.7 compared to a temporal dimension of 0.2).

In various examples, if one or more of the calculated cosine similarity values are below their respective threshold similarity values, the generated response 302 may be prevented from being displayed to the original requesting user. A message may be presented indicating that the generated response showed a potential for being inaccurate and to try a new prompt.

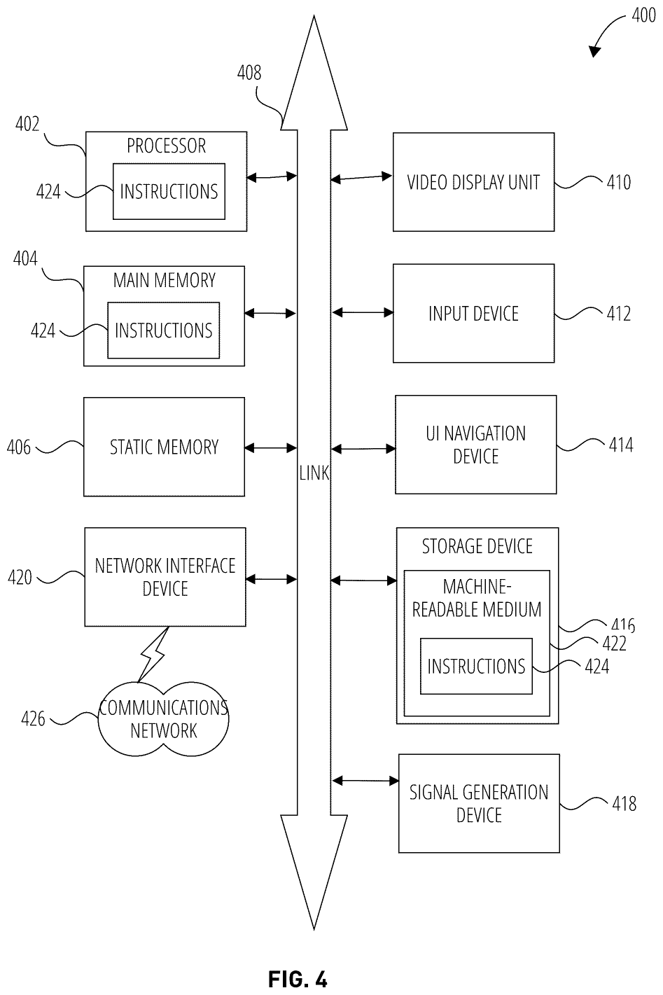

FIG. 4 is a block diagram illustrating a machine in the example form of computer system 400, within which a set or sequence of instructions may be executed to cause the machine to perform any of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) Network environments. The machine may be an onboard vehicle system, wearable device, personal computer (PC), tablet PC, hybrid tablet, personal digital assistant (PDA), mobile telephone, or any machine capable of executing instructions (sequential or otherwise) that specify actions to be taken by that machine. Further, while only a single machine is illustrated, the term “machine” includes any collection of machines that individually or jointly execute a set (or multiple sets) of instructions to perform any of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 400 includes at least one processor 402 (e.g., a central processing unit (CPU), a graphics processing unit (GPU) or both, processor cores, compute nodes, etc.), a main memory 404, and a static memory 406, which communicate with each other via a link 408. The computer system 400 may include a video display unit 410, an input device 412 (e.g., a keyboard), and a user interface UI navigation device 414 (e.g., a mouse). In an example, the video display unit 410, input device 412, and UI navigation device 414 are incorporated into a single device housing, such as a touchscreen display. The computer system 400 may additionally include a storage device 416 (e.g., a drive unit), a signal generation device 418 (e.g., a speaker), a network interface device 420, and one or more sensors (not shown), such as a global positioning system (GPS) sensor, compass, accelerometer, or other sensors.

The storage device 416 includes a machine-readable medium 422 on which one or more sets of data structures and instructions 424 (e.g., software) embodying or utilized by any of the methodologies or functions described herein. The instructions 424 may also reside, completely or at least partially, within the main memory 404, the static memory 406, or within the processor 402 during execution thereof by the computer system 400, with the main memory 404, the static memory 406, and the processor 402 also constituting machine-readable media.

While the machine-readable medium 422 is illustrated in an example embodiment to be a single medium, the term “machine-readable medium” may include a single medium or multiple media (e.g., a centralized or distributed database or associated caches and servers) that store the instructions 424. The term “machine-readable medium” shall also be taken to include any tangible medium that is capable of storing, encoding, or carrying instructions for execution by the machine and that causes the machine to perform any one or more of the methodologies of the present disclosure or that is capable of storing, encoding or carrying data structures utilized by or associated with such instructions. The term “machine-readable medium” includes, but is not limited to, solid-state memories and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device may be a machine-readable medium 422 that excludes transitory signals.

The instructions 424 may be transmitted or received over a communications network 426 using a transmission medium via the network interface device 420 utilizing a transfer protocol (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine and includes digital or analog communications signals or other intangible mediums to facilitate communication of such software

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

What is claimed is:

1. A method comprising:
receiving, using a processing unit, a prompt for a generative artificial intelligence model from a computing device;
identifying, using the processing unit, an entity in the prompt;
querying a knowledge graph for verified information associated with the entity;
inputting, using the processing unit, the prompt into the generative artificial intelligence model;
in response to the inputting, receiving a generated response from the generative artificial intelligence model;
generating a similarity value between the generated response and the verified information;
determining that the similarity value is below a threshold similarity; and
based on the determining, preventing a display of the generated response.

2. The method of claim 1, further comprising:
inputting, using the processing unit, the prompt into an entity recognition model;
in response to the inputting, receiving an output from the entity recognition model, the output identifying a set of entities in the prompt and a weight for each entity in the set of entities, the weight associated with an importance of the entity relative to other entities in the set of entities in the prompt; and
selecting the entity from the set of entities based on the weight of the entity.

3. The method of claim 2, further comprising:
calculating an entity ambiguity score for the entity;
determining the entity ambiguity score exceeds a threshold;
based on the entity ambiguity score exceeding the threshold, transmitting a prompt requesting additional information about the entity; and
receiving the additional information.

4. The method of claim 3, further comprising:
prior to the inputting, automatically modifying the prompt based on the received additional information.

5. The method of claim 1, further comprising:
prior to the inputting, calculating a creative intent value of the prompt;
determining the creative intent value exceeds a threshold; and in response:
transmitting a response to the computing device requesting an update to the prompt;
receiving the update to the prompt; and
inputting the updated prompt into the generative artificial intelligence model.

6. The method of claim 1, wherein the knowledge graph is configured to store verified information about entities across multiple categorical dimensions.

7. The method of claim 6, wherein querying the knowledge graph for verified information associated with the entity includes querying the knowledge graph for verified information of the entity for a geographic dimension and temporal dimension of the multiple categorical dimensions.

8. The method of claim 7, wherein generating the similarity value between the generated response and the verified information includes:
calculating a cosine similarity value based on the verified information of the entity for the geographic dimension and the generated response; and
calculating a cosine similarity value based on the verified information of the entity for the temporal dimension and the generated response.

9. The method of claim 6, wherein the knowledge graph is stored in a graph database format.

10. A non-transitory computer-readable medium comprising instructions, which when executed by a processing unit, configure the processing unit to perform operations comprising:
receiving a prompt for a generative artificial intelligence model from a computing device;
identifying an entity in the prompt;
querying a knowledge graph for verified information associated with the entity;
inputting the prompt into the generative artificial intelligence model;
in response to the inputting, receiving a generated response from the generative artificial intelligence model;
generating a similarity value between the generated response and the verified information;
determining that the similarity value is below a threshold similarity; and
based on the determining, preventing a display of the generated response.

11. The non-transitory computer-readable medium of claim 10, wherein the instructions, which when executed by the processing unit, further configure the processing unit to perform operations comprising:
inputting the prompt into an entity recognition model;
in response to the inputting, receiving an output from the entity recognition model, the output identifying a set of entities in the prompt and a weight for each entity in the set of entities, the weight associated with an importance of the entity relative to other entities in the set of entities in the prompt; and
selecting the entity from the set of entities based on the weight of the entity.

12. The non-transitory computer-readable medium of claim 11, wherein the instructions, which when executed by the processing unit, further configure the processing unit to perform operations comprising:
calculating an entity ambiguity score for the entity;
determining the entity ambiguity score exceeds a threshold;
based on the entity ambiguity score exceeding the threshold, transmitting a prompt requesting additional information about the entity; and
receiving the additional information.

13. The non-transitory computer-readable medium of claim 12, wherein the instructions, which when executed by the processing unit, further configure the processing unit to perform operations comprising:
prior to the inputting, automatically modifying the prompt based on the received additional information.

14. The non-transitory computer-readable medium of claim 10, wherein the instructions, which when executed by the processing unit, further configure the processing unit to perform operations comprising:
prior to the inputting, calculating a creative intent value of the prompt;
determining the creative intent value exceeds a threshold; and in response:
transmitting a response to the computing device requesting an update to the prompt;
receiving the update to the prompt; and
inputting the updated prompt into the generative artificial intelligence model.

15. The non-transitory computer-readable medium of claim 10, wherein the knowledge graph is configured to store verified information about entities across multiple categorical dimensions.

16. The non-transitory computer-readable medium of claim 15, wherein querying the knowledge graph for verified information associated with the entity includes querying the knowledge graph for verified information of the entity for a geographic dimension and temporal dimension of the multiple categorical dimensions.

17. The non-transitory computer-readable medium of claim 16, wherein generating the similarity value between the generated response and the verified information includes:
calculating a cosine similarity value based on the verified information of the entity for the geographic dimension and the generated response; and
calculating a cosine similarity value based on the verified information of the entity for the temporal dimension and the generated response.

18. The non-transitory computer-readable medium of claim 15, wherein the knowledge graph is stored in a graph database format.

19. A system comprising:
a processing unit; and
a storage device comprising instructions, which when executed by the processing unit configure the processing unit to perform operations comprising:
receiving a prompt for a generative artificial intelligence model from a computing device;
identifying an entity in the prompt;
querying a knowledge graph for verified information associated with the entity;
inputting the prompt into the generative artificial intelligence model;
in response to the inputting, receiving a generated response from the generative artificial intelligence model;
generating a similarity value between the generated response and the verified information;
determining that the similarity value is below a threshold similarity; and
based on the determining, preventing a display of the generated response.

20. The system of claim 19, wherein the instructions, which when executed by the processing unit, further configure the processing unit to perform operations comprising:
inputting the prompt into an entity recognition model;
in response to the inputting, receiving an output from the entity recognition model, the output identifying a set of entities in the prompt and a weight for each entity in the set of entities, the weight associated with an importance of the entity relative to other entities in the set of entities in the prompt; and
selecting the entity from the set of entities based on the weight of the entity.
